(19) United States
(12) Patent Application Publication
(10) Pub. No.: US 2009/0123777 A1
(43) Pub. Date: May 14, 2009

(54) METHOD OF IMPROVING THE PERFORMANCE OF A HYDRODYNAMIC SURFACE

(75) Inventor: Edward McComas, Palm City, FL (US)

Correspondence Address: MCCORMICK, PAULDING & HUBER LLP, CITY PLACE II, 185 ASYLUM STREET, HARTFORD, CT, 06103, US

(73) Assignee: UCT COATINGS LLC.

(21) Appl. No.: 11/939,762

(22) Filed: Nov. 14, 2007

(51) Int. Cl. B32B 3/30; B05D 5/00

(52) U.S. Cl. 428/600; 427/256

(57) ABSTRACT

An apparatus for use in a liquid environment has a metallic substrate material with a nodular nickel boron coating applied using an electroless plating process. Where the coated apparatus comes into contact with a fluid, the coated apparatus exhibits improved hydrodynamic performance, including decreased cavitation and erosion of the substrate. The coating also decreases the drag coefficient between the coated surface and liquid. Moreover, the surface of the coated article experiences less marine growth, and any growth that does accumulate is easier to remove.

### FIELD OF THE INVENTION

The present invention relates to a nickel boron coating for use on hydrodynamic surfaces. More particularly, it relates to improving the hydrodynamic performance of metallic articles used in a hydrodynamic environment.

### BACKGROUND OF THE INVENTION

Articles moving through or in contact with liquids are subject to stresses and strains. These conditions are aggravated when the relative speed of the fluid past the article is increased or when there is significant variation in the relative speed local to the articles, as may occur with highly turbulent flow conditions. These situations give rise to cavitation when local fluid pressures are reduced below vapor pressure. This cavitation then results in both erosion and, in some cases, accelerated corrosion. In turn, the physical damage caused by corrosion and/or erosion will further reinforce the magnitude and severity of the cavitation region, resulting in acceleration of physical damage and a reduction in efficiency for the system.

Cavitation occurs when a volume of liquid is subjected to a sufficiently low pressure. For example, as a propeller moves in a fluid, such a low-pressure environment is often created at the surface of each hydrodynamic surface. The lower pressure causes the liquid to locally vaporize, forming bubbles. When the bubbles collapse or implode due to the higher pressure of the surrounding medium, they can cause pitting to occur on the propeller when the released energy comes in contact with the rapidly rotating propeller.

Some examples of articles that experience cavitation are pumps, propellers, waterjets, tunnel thrusters, hydraulic machinery, and water turbines.

In order to protect these articles from the effects of cavitation and reduce additional damage or friction, they often have a coating applied to them, such as flame-sprayed materials or epoxy paint. The plating or deposition of metal alloys by chemical or electrochemical reduction of metal ions on the surface of an article to modify the characteristics of its surface for both decorative and functional purposes is well known in the art. In particular, the process of deposition of metal/metal alloy coatings on both metal and activated non-metal substrates to enhance surface properties such as hardness and resistance to corrosion and wear is known.

Articles used in a marine environment also are affected by marine growth, or fouling. Such articles include propellers, hulls, and other surfaces in contact with water. Fouling causes increased friction, cavitation, and degraded propulsive efficiency. Besides reduced efficiency, prolonged growth can damage the hull of a ship. Fouling in pipes can cause corrosion, reduced output, and increased maintenance costs.

Attempts to resist fouling on marine propellers by application of anti-fouling coatings have spanned over two decades. Initial attempts involved ablative paint with a composition similar to marine hull anti-fouling paints. However, these types of coatings release toxins that are not safe for the environment. The known paints are also not immune to damage from cavitation, which limits the useful lifespan of the paint. In recent years, the increase in fuel prices has brought renewed interest in developing propeller coatings with anti-fouling properties.

### SUMMARY OF THE INVENTION

An object of the present invention is to reduce the formation and initiation of cavitation on a hydrodynamic surface by applying a nodular nickel boron coating to the surface.

Another object of the present invention is to increase the efficiency of a hydrodynamic surface by applying a nodular nickel boron coating to the surface.

Still another object of the present invention is to apply a nodular nickel boron coating on a hydrodynamic surface to decrease the amount of marine growth that accumulates on the surface and to simplify removal of the marine growth that does happen to accumulate.

According to one aspect of the present invention, an apparatus with a metallic substrate submerged in a liquid environment is coated with a nodular nickel boron coating using an electroless plating operation.

### BRIEF DESCRIPTION OF THE DRAWINGS

FIG. 1 is a graph showing the measured difference in pump efficiencies between coated and uncoated impellers operated at various unit flow rates.

FIG. 2 is a graph showing the cavitation limit for the coated and uncoated impeller.

### DETAILED DESCRIPTION OF THE PREFERRED EMBODIMENT

Nickel boron coatings have been described in U.S. Pat. Nos. 6,319,308; 6,066,406; and 5,019,163. These references are incorporated herein by reference. Usually, an electroless coating process as shown in these patents is used to deposit these coatings on surfaces. These coatings have a nodular and columnar structure.

Previously, it was known that nodular nickel boron coatings improve mechanical performance. Specifically, the coating was used on metal parts that would slide against each other. For example, U.S. Pat. No. 6,782,650 describes the use of the coating with firearms. The present invention is related to the unexpected hydrodynamic performance benefits of the coating, such as higher resistance to cavitation and improved fuel economy. Other previously unknown benefits will be disclosed herein.

The present invention is directed to an article for use in a liquid environment, wherein a nodular nickel boron coating is applied to reduce friction and increase the hydrodynamic performance of the article. The coating also decreases marine fouling that accumulates on the article. Nodular and columnar nickel boron coatings made by methods disclosed in the above patents have a low coefficient of friction. This process results in a columnar structure with nodules in the surface layer. A nodular topographic surface profile can be produced in other coatings by blasting the surface with hard particles prior to plating, but this creates an inferior coating when compared to electroless columnar/nodular nickel boron coatings. The columnar structure is best produced by electroless deposition of the nickel boron coating.

The coating composition is useful to substrates that come in contact with, or are used primarily in, a hydrodynamic environment. As used according to the present invention, a hydrodynamic environment includes all fluid dynamic environments. The most common hydrodynamic environment is water, but the term applies to any liquid such as oil. Substrates with the nodular nickel boron coating that move through a liquid experience increased hydrodynamic performance, which, in turn, leads to greater fuel efficiency. The nodular nickel boron coating reduces the inception of cavitation, which reduces erosion.

The substrate coated with the nodular nickel boron also accumulates less marine growth and barnacles in use compared to an uncoated article. Regarding the marine growth that does accumulate despite the coating, less energy is required to remove it from the article. The nodular nickel coating inherently increases hydrodynamic performance, but its anti-fouling properties also create improved efficiency due to the reduced growth on propellers, hulls, and other components. Fouling can also occur in pipes, which can cause corrosion, reduced output due to blockage, and increased maintenance costs in fixing pipes and preventing fouling. The nodular nickel coating reduces these problems since less growth is likely to occur.

By applying the nodular nickel coating to the surface of a desired substrate, the wear life of the substrate can be extended beyond the wear life provided by bare material or prior art coatings. Although examples have been given of substrates that are in contact with an aqueous environment, the present invention can be applied to any substrate in a liquid environment. The benefits associated with the non-mechanical interaction of applying the nodular nickel coating to these types of substrates were previously unknown. Prior disclosures of nodular nickel coatings were limited to its uses on mating surfaces of mechanical apparatuses.

Electroless plating is achieved by forming a thin layer of the nickel boron coating on a solid substrate. The method involves several reactions in an aqueous solution, which occur without electrical power applied to the bath itself. Before performing the electroless plating, the substrate may be cleaned by a cleaning solution or a series of cleaning solutions. Any known degreasing method may also be used to remove oils from the surface of the substrate.

The substrate may then be placed in a nickel strike solution or an acid solution for surface activation. Surface activation can also be achieved via grit blasting.

Any conventional nickel plating bath for electroless deposition using a borohydride reducing agent can be used for co-deposition of the hard particles. Conventional nickel plating usually has the following constituents. First, an effective amount of nickel ions (about 0.175 to about 2.10 moles per gallon) is used. Calculations are based on a nickel chloride range of 0.05 to 0.6 pounds per gallon. A preferred range of nickel ions is about 0.35 to about 1.57 moles per gallon based on 0.1 to about 0.45 pounds per gallon of nickel chloride. Second, an effective amount of a chemical agent is used to adjust the pH of the bath to between about 10 and about 14. Third, an effective amount of usually about 2.26 to about 6.795 moles per gallon metal ion complexing agent is used. Preferably, 3.3 to 3.8 moles per gallon of the complexing agent are used. Fourth, an effective amount of reducing agent (usually about 0.03 to about 0.1 moles per gallon of coating bath of a borohydride reducing agent based on BH4) is used. Preferably, 0.045 to 0.08 moles per gallon of coating bath of the reducing agent are used. Fifth, an effective amount of a stabilizer is used. The stabilizer usually comprises about 6% of the solution. Lead tungstate and thallium are examples of stabilizers that can be used. Optionally, other metal ions are included.

After the electroless deposition of the nickel boron, the nodular nickel coating can be polished to decrease any surface roughness. The surface roughness can be reduced using conventional polishing techniques. The extra polishing can provide further hydrodynamic benefits and increased fuel efficiency.

Tests were done to determine the difference in hydrodynamic performance between a marine impeller coated with the nodular nickel boron coating and the same type of impeller without coating. Pump efficiencies and cavitation limits were measured at different flow rates and operating conditions. A pump (a Rolls-Royce pump design) was tested in a conventional cavitation tunnel before and after coating the impeller. The impeller was machined from a round bar of aluminum while the guide vane chamber was made of composite material (Alumide) using rapid prototyping. The impeller housing was made of Plexiglas. Tip clearance of the impeller was designed to be 0.2 mm. Before the tests, the average clearance was measured to be about 0.25 mm.

As stated above, the tests were done in a pump loop set-up in a conventional cavitation tunnel using pump models with an inlet diameter of 200 mm. An inlet created close to uniform flow into the pump. Downstream of the pump, a pipe system took the water to auxiliary pumps that control the flow rate and brought the water back to the tunnel after passing a flow meter. Torque was measured with a dynamometer inside the pump hub and directly connected to the impeller in order to eliminate uncertainty caused by friction in bearings and seals. Head rise was obtained by measuring wall static pressure and using average values of velocities based on flow rate and sectional area.

The pump efficiency test measured flow rate, shaft speed, and torque. Head rise was calculated using measured wall static pressure and average values of velocities based on flow rate and sectional area. The test conditions were selected after obtaining preliminary pump characteristics. The following flow rates relative to the flow rate at maximum pump efficiency were chosen: 0.80, 0.88, 0.93, 0.97, 1.00, 1.03, 1.07, 1.12, and 1.20 m³/s.

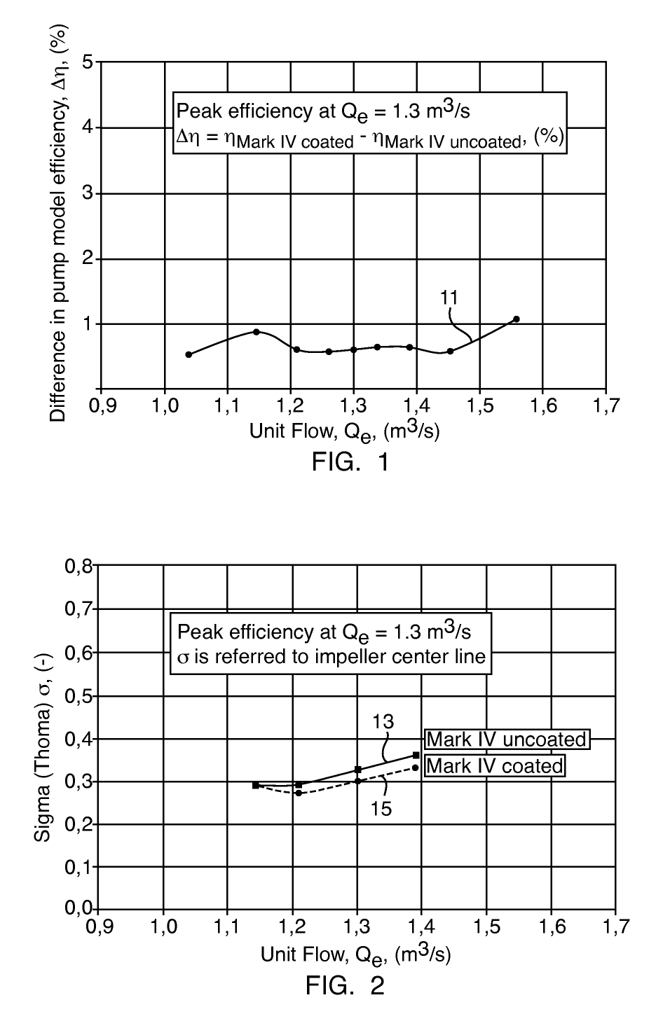

Pump efficiency was measured at non-cavitating conditions. FIG. 1 is a graph showing the difference in pump efficiency between the coated and uncoated impeller at different unit flow rates. Curve 11 was plotted by showing the percent difference in pump model efficiency on the y-axis versus the unit flow rate on the x-axis. As shown, the coating improved the pump efficiency about 0.5-1.0%.

The purpose of the cavitation test is to determine the Thoma cavitation number at which the pump efficiency drops 1%. Tests were conducted by gradually reducing tunnel pressure at four different flow rates (1.14, 1.21, 1.30, and 1.39 m³/s). FIG. 2 is a graph showing the cavitation limit for the coated and uncoated impeller. To some extent, these results are based on extrapolation. Curve 13 shows the Thoma cavitation number for the uncoated impeller at different unit flow rates. Similarly, curve 15 shows the Thoma cavitation number for the coated impeller at different unit flow rates. As shown, the coating has a positive effect on the cavitation limits of the pump.

When the impeller was coated with the nodular nickel boron coating, pump efficiency increased by about 0.6% around the peak efficiency of the pump. The nodular nickel boron coating also had a positive effect on cavitation. Measurements showed that cavitation is reduced by about 8% around the peak efficiency of the pump. The cavitation that was observed for the coated impeller was slightly smaller in volume and more intermittent compared to the uncoated impeller. Therefore, the measurements show that the coating has a positive effect on both pump efficiency and cavitation performance of the pump.

The present invention described above provides for the application of a nodular nickel boron coating to substrates that are in contact with a liquid environment. When applied to substrates in contact with a liquid environment, the formation and initiation of cavitation is reduced and the drag coefficient, as determined by the pump efficiency data, between the coated surface and the liquid is reduced. Although the benefits of coating mating surfaces of metal parts with nodular nickel boron have been disclosed previously, it was heretofore not known in the art that a metal part with nickel boron provides significant hydrodynamic benefits when the metal part is used in a liquid environment. The present invention describes the previously unknown benefits of applying a nodular nickel boron coating to substrates used in a liquid environment.

While the invention has been described with reference to the preferred embodiments, it will be understood by those skilled in the art that various obvious changes may be made, and equivalents may be substituted for elements thereof, without departing from the essential scope of the present invention. Therefore, it is intended that the invention not be limited to the particular embodiments disclosed, but that the invention includes all embodiments falling with the scope of the appended claims.

What is claimed is:

1. An apparatus for use in a liquid environment, said apparatus comprising:
a metallic substrate material; and
a nodular nickel coating applied to said substrate material.

2. The apparatus according to claim 1, wherein said coating resists fouling of said substrate material in a marine environment.

3. The apparatus according to claim 1, wherein a stabilizer is used during the application of said nodular nickel coating.

4. The apparatus according to claim 3, wherein said stabilizer is lead tungstate.

5. The apparatus according to claim 3, wherein said stabilizer is thallium.

6. The apparatus according to claim 1, wherein said nodular nickel coating is polished.

7. The apparatus according to claim 1, wherein said nodular nickel coating is applied electrolessly to said substrate material.

8. A process for coating a surface of a solid member for use in a hydrodynamic environment, said process comprising applying a nodular nickel coating to said surface.

9. The process according to claim 8, wherein said coating resists fouling of said surface in a marine environment.

10. The process according to claim 8, said process further comprising using a stabilizer during application of said nodular nickel coating.

11. The process according to claim 10, wherein said stabilizer is lead tungstate.

12. The process according to claim 10, wherein said stabilizer is thallium.

13. The process according to claim 8, said process further comprising polishing said nodular nickel coating.

14. The process according to claim 8, wherein said nodular nickel coating is applied by electroless deposition of nickel boron

15. A method for improving the performance of a hydrodynamic surface comprising the step of:
applying a nodular nickel coating to said hydrodynamic surface.

16. The method according to claim 15, wherein said coating resists fouling of said surface in a marine environment.

17. The method according to claim 15, said method further comprising using a stabilizer during the application of said nodular nickel coating.

18. The method according to claim 17, wherein said stabilizer is lead tungstate.

19. The method according to claim 17, wherein said stabilizer is thallium.

20. The method according to claim 15, said method further comprising polishing said nodular nickel coating.

21. The method according to claim 15, wherein said nodular nickel coating is applied by electroless deposition of nickel boron.
